(19) United States
(12) Patent Application Publication
(10) Pub. No.: US 2008/0194415 A1
(43) Pub. Date: Aug. 14, 2008

(54) Method for structuring and cleaning steric macromolecular data

(76) Inventors: Zoltan Szabadka, Veszprem (HU); Vince Grolmusz, Budapest (HU)

Correspondence Address: VINCE GROLMUSZ, UGRON GABOR U.8., BUDAPEST, 1118, omitted

(21) Appl. No.: 11/847,327

(22) Filed: Aug. 29, 2007

Related U.S. Application Data
(60) Provisional application No. 60/889,317, filed on Feb. 12, 2007.

(51) Int. Cl. C40B 20/00

(52) U.S. Cl. 506/2

(57) ABSTRACT

The fast-growing Protein Data Bank contains the description of tens of thousands structures today, being one of the richest source of structural biological information on the Earth. Started to exist as the computer-readable depository of crystallographic data complementing printed articles, the proper interpretation of the content of the individual files in the PDB still frequently needs the detailed information found in the citing publication. This fact implies that the fully automatic processing of the whole PDB is a very hard task. Here a mathematical and graph theoretical method is disclosed for automatically repairing, re-organizing and re-structuring PDB data. In a preferred embodiment of the invention, the results of this cleaning procedure is applied for the reliable and automatic identification of all the protein-ligand complexes and binding sites in the data.

### BACKGROUND OF INVENTION

The increasing size and accuracy of structural information stored in the Protein Data Bank (Berman, H., Westbrook, J., Feng, Z., Gilliland, G., Bhat, T., Weissig, H., Shindyalov, I., and Bourne, P.: The Protein Data Bank. Nucleic Acids Research 28, 235-242 (2000)) make possible large-scale, fully automated in silico studies involving thousands of protein-ligand complexes and binding sites. The most important implication of such studies were the structural classification of binding sites on protein-surfaces, applicable for the prediction and modeling of protein-ligand interactions. In the present invention we disclose a method for structurally analyze and re-build the whole Protein Data Bank, identify protein-ligand complexes and binding sites.

It is a highly non-trivial problem to automatically identify protein-ligand complexes in the Protein Data Bank. The HET label of atoms in the PDB files may denote metals, atoms of modified residues, even atoms in small molecules added in crystallization and also covalently bound ions. Consequently, the HET atoms alone will not identify ligands. Small pieces of broken peptide-chains erroneously may also be seen to be ligands. Obviously, by careful human examination of the remark fields of the individual PDB entries, together with the study of journal publications where the solution of the protein-structure was first reported would solve these problems, but they are definitely inadequate for automatic processing of the whole PDB, even by the most powerful textual data-mining techniques.

The PDBsum pictorial data base (Laskowski, R. A.: PDBsum: summaries and analyzes of PDB structures. Nucleic Acids Research 29, 221-222 (2001)) contains reliable structural information on ligands and binding sites: hand-examination of single entries is comfortable, automatic examination of large sets of graphical data is impossible. The sc-PDB database (Paul, N., Kellenberger, E., Bret, G., Muller, P., and Rognan, D.: Recovering the true targets of specific ligands by virtual screening of the Protein Data Bank. Proteins: Structure, Function, and Bioinformatics 54(4), 671-680 (2004)) was made by automatic processing of the whole PDB, using, among others, textual information in the remark and title fields of the entries in deciding if a structure is a complex or not.

A more reliable, fully automatic method is disclosed hereby for identifying complexes and cleaning and re-structuring macromolecular data.

### SUMMARY OF INVENTION

The fast-growing Protein Data Bank contains the description of tens of thousands structures today, being one of the richest source of structural biological information on the Earth. Started to exist as the computer-readable depository of crystallographic data complementing printed articles, the proper interpretation of the content of the individual files in the PDB still frequently needs the detailed information found in the citing publication. This fact implies that the fully automatic processing of the whole PDB is a very hard task. Here a strict mathematical and graph theoretical method is disclosed for automatically repairing, re-organizing and re-structuring PDB data. In a preferred embodiment of the invention, the results of this cleaning procedure are applied for the reliable and automatic identification of all the protein-ligand complexes and binding sites in the data.

### BRIEF DESCRIPTION OF DRAWINGS

FIG. 1 contains the method of building protein chains from the description of the amino acid sequences in the database. The result of the building process is the polypeptide chain.

### DETAILED DESCRIPTION

The reliability comes from the fact that we present a new pre-processing algorithm that works on the mmCIF (macromolecular Crystallographic Information File) format of the PDB, and uses the International Chemical Identifier (InChI™) of the International Union of Pure and Applied Chemistry (IUPAC). The method disclosed checks the entries for errors and inconsistencies, marks missing atoms, decomposes the structures into protein-, nucleic acid- and polysaccharide chains as well as various types of ligand molecules (e.g., peptides, cofactors/coenzymes, metals, etc.), distinguishes between covalently and non-covalently bound ligands, and identifies different binding sites. In the process we are using as little as possible from the labels from the remark-fields in the file in the PDB. The result is a strictly structured, homogeneous database, independent from labeling errors, that is adequate for processing diverse queries and serving intricate data-mining applications.
The input of the method is a computer readable form of the descriptions of the 3D structures of the macromolecules. In a preferred embodiment of the invention the input is the mmCIF file of the PDB entry and the PDB Chemical Component Dictionary which contains the chemical structure of each monomer in the PDB.
The output of the algorithm is the cleaned and re-structured database, containing the rich-structured descriptions of the macromolecules.

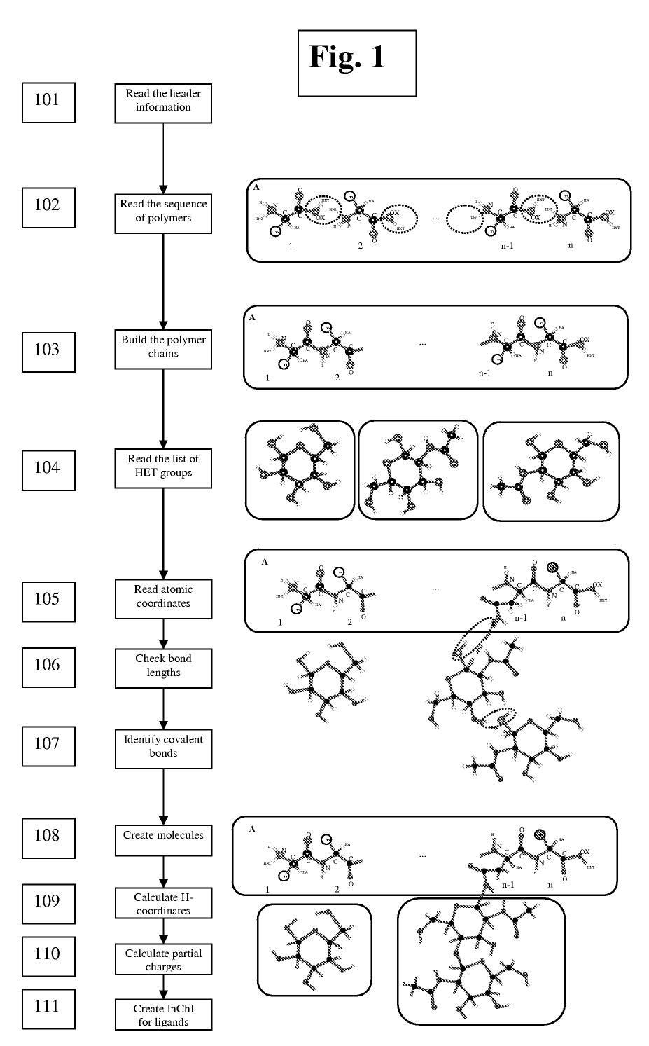

We explain step-by-step how an entry from the PDB, given in the mmCIF format, is processed, checked for errors and is finally decomposed into polymer chains and ligand molecules. See FIG. 1 for a pictorial description of the algorithm.

The PDB entry in mmCIF format consists of several tables, called “data categories”, and the attributes in a table are called “data items”. The most important mmCIF data categories are:
struct_asym: List of the components in the asymmetric unit. Each component has an asym id.
pdbx_poly_seq_scheme: Describes the sequence of monomers in a polymer entity.
pdbx_nonpoly_scheme: List of the monomers belonging to the non-polymer entities.
atom_site: Coordinate data for atoms, whose positions could be experimentally determined.

The following entry header information is stored in the resulting database disclosed here:
The species of the source organism(s) from which the structure was obtained. This can be found in the entity_src_gen table if the source was genetically manipulated, otherwise in the entity_src_nat table.
The method used in the experiment (exptl.method), e.g., X-Ray Diffraction, NMR.
The resolution of the structure (refine.Is_res_high).

In an mmCIF file, the contents of the asymmetric unit are listed in the table struct_asym. Each item (also called entity) in this list has an asym id. The type of an entity can be polymer, non-polymer or water. Each polymer entity has also a polymer type.

From now on, we call the elements of the PDB Chemical Component Dictionary (formerly the HET Group Dictionary), “monomers”.

We define a protein chain as a polymer entity of type “polypeptide(L)”, if it is long enough, in the preferred embodiment of this disclosure: ten monomers long, and a DNA/RNA chain as a polymer entity, which is long enough; in the preferred embodiment at least 5 monomers long and its type is either “polydeoxiribonucleotide”, “polyribonucleotide”, or a great fraction of its monomers are nucleic acids (A, C, G, I, T, U monomer id); in the preferred embodiment we need that at least half of the monomers are of the type mentioned.

At this point the list of monomers that make up a polymer chain is identified. The covalent structure of these monomers (the so-called “connection table”) is read from the PDB Chemical Component Dictionary (formerly HET Group Dictionary, HGD).

Connecting the monomers to obtain the covalent structure of the whole chain is performed by adding the monomers to the chain one-by-one (see FIG. 1).

In the case of protein chains, when we add a new amino acid (i.e., a monomer), we remove the atoms OXT and HXT from the end of the chain, and the atom HN2 (it is sometimes denoted by 2HN) from the new monomer, and add a covalent bond between the atoms C and N. In the case of amino acid PRO, we remove both HT1 and HT2. If, in the case of a non-standard amino acid (i.e., protein monomer), the above mentioned atoms are not present, we refuse to make chain. In this way we can ensure that only proteins with standard peptide bonds will be processed, without excluding the numerous modified amino acid monomers that can be found in the HGD. We use a similar protocol in the case of DNA/RNA chains as well.

Selecting the initial set of ligands: After creating the connection table for the polymer chains, the list of monomers from the table pdbx_nonpoly_scheme will be read. The initial set of ligand molecules will be these, plus the monomers from the polymer entities that were not long enough (these will form the oligopeptide ligands, for example). We obtain their connection table from the HGD. If it cannot be found there, an error is given. In this way, we will work only with previously checked components.

What we now have, is the covalent structure of few polymer chains, and the initial set of ligands. At this step the 3D atomic coordinates of the atoms are not processed yet. This state is denoted on FIG. 1 by empty circles, representing the atoms.

Inserting atomic coordinates: The coordinates of the atoms can be found in the mmCIF table atom_site. By going through each row of this table, we need to identify the atom in our previously built covalent model, that this row is referring to. This is not always an easy task, because there are four different numbering schemes used simultaneously in mmCIF files, but we try a few combinations before giving up, and each time we also check that the monomer id of this row matches the monomer id of the atom. If we fail to find the atom for a certain row, we give an error message and stop processing. After reading the table atom_site, there will be several atoms, whose coordinates are known. These atoms are denoted by the filled circles in the FIG. 1. But unfortunately, there will still be several atoms whose coordinates are unknown. We will refer to them as “missing atoms” hereafter. They are denoted by the still unfilled circles on the FIG. 1. There are three different reasons for an atom to be missing.
First, the hydrogen atoms can not be “seen” on the electron density maps, so they are usually missing, this is a completely normal case.
Second, there can be flexible chain segments, a few residues at the beginning or at the end, or a longer loop at the middle of the chain. The position of these flexible parts can not be determined, so the atoms in them are all missing, not only the hydrogen atoms.
The third reason: there can be atoms, that are in this initial ligand set only and will not be part of the final structure as we shall see later.

The next step is verifying distances. Now that the largest part of the atoms of our molecules are located in the space by their coordinates, we can check whether the bond lengths are correct. It is done by taking all pairs of atoms that are in the same monomer, and check whether their distance is in accordance with the connectivity information in the HGD. That is, if they are covalently bound, the proportion of their distance to the sum of their covalent radii should be close to one (in this case we call the atoms to be in “covalent range”); and if they are not, then it should be more than 1 plus a suitable constant. The bound atom-pairs, that are not bound covalently, should be closer than the sum of their Van der Waals radii, with some suitable error bound added. The lengths of the peptide bonds, that were added by our process, are also checked. The deviances are recorded in a separate table in the database, so that one can use this information, when selecting the most exact structures.

Building multi-monomer ligands: At this point, we still have the initial set of ligands. A molecule in the final set can consist of two or more such monomers (described with three-letter HGD-code), bound covalently. To identify such covalent bonds in a particular embodiment of the method, we select all pairs of atoms in the entry that are situated closer than 6 Å.

This may be achieved by several mathematical methods well known for those skilled in the art; in a particular embodiment we perform that by building a kd-tree (Bentley, J. L.: Multidimensional binary search trees used for associative searching. Communications of the ACM 18(9), 509-517 (1975)) on the atoms, avoiding the examination of all pairs, and saving a considerable amount of computational time. As a byproduct, the pairs of atoms that are too close to each other are also obtained and recorded as a warning in the database.

For the covalent bonds we consider the atom pairs that are in covalent range, as defined above.

In another particular embodiment of the invention, we actually add a covalent bond, if at least one of the following three conditions is met:
There is a missing hydroxyl group on one atom, and at least one missing hydrogen on the other atom. In this case we remove these three atoms, and add the covalent bond. This way, the number of missing heavy atoms can decrease.
Both atoms are sulfur of a CYS residue. In this case we remove a hydrogen from each atom, and add the covalent bond.
One atom is a metal, and the other atom is a non-metal that can donate a lone pair. In this case we simply add a coordinate covalent bond.

If a covalent bond was made between the atoms of two ligand molecules in the above process, then these two molecules will be merged into one. If the bond was made between the atom of a polymer and an atom of a ligand, then we do not merge them to preserve the linear structure of the polymer, but record this bond in a separate table in the database.

Finalizing the set of ligands: After creating all possible covalent bonds, we have the set of ligands.

Although the subject invention has been described with respect to particular embodiments, it will be readily apparent to those having ordinary skill in the art to which it pertains, that changes and modifications may be made thereto without departing from the spirit or scope of the subject invention as defined by the appended claims.

What is claimed is:

1. A fully automated method for cleaning, verifying and re-building macromolecular spatial data, comprising the following steps:
(a) the input descriptor file is read;
(b) the types of the molecular entities in the descriptor file are identified as polymer or a non-polymer entities;
(c) if the entity is a polymer, then monomer members of the polymer type molecular entity are identified with the help of a list of monomer molecules, organized into a monomer dictionary;
(d) if the entity is a polymer, then based on the type of the monomer entities, the type of the polymer entity is determined;
(e) the covalent structure of the monomers present in the molecular entity are then read from the monomer dictionary;
(f) if the entity is a polymer, then next the polymer entity is built up from the monomers given in the monomer dictionary by creating molecular bonds between the corresponding monomers, forming the polymer entity;
(g) three-dimensional atomic coordinates are then corresponded both to the atoms of the polymer entity and also to the non-polymer entities, using the input descriptor file;
(h) molecular bonds are built next, using the atomic coordinates inserted in step (g) to determine distances: atoms in binding distances are connected by the appropriate molecular bonds, and these bonds are recorded in the database;
(i) the output is generated from the re-built molecular structures in a suitable machine-readable format.

2. As in claim 1, where the descriptor file is an mmCIF file from the Protein Data Bank.

3. As in claim 1, where the descriptor file is a PDB-file from the Protein Data Bank.

4. As in claim 1, where the descriptor file is an xml-formatted molecular descriptor-file from the Protein Data Bank.

5. As in claim 2, where the monomer dictionary file is the “PDB Chemical Component Dictionary” (it was formerly called “the HET Group Dictionary”).

6. As in claim 3, where the monomer dictionary file is the “PDB Chemical Component Dictionary” (it was formerly called “the HET Group Dictionary”).

7. As in claim 4, where the monomer dictionary file is the “PDB Chemical Component Dictionary” (it was formerly called “the HET Group Dictionary”).

8. A fully automated method for cleaning, verifying and re-building macromolecular spatial data, comprising the following steps:
(a) the input descriptor file is read;
(b) the types of the molecular entities in the descriptor file are identified as polymer or a non-polymer entities;
(c) if the entity is a polymer, then monomer members of the polymer type molecular entity are identified with the help of a list of monomer molecules, organized into a monomer dictionary;
(d) if the entity is a polymer, then based on the type of the monomer entities, the type of the polymer entity is determined;
(e) the covalent structure of the monomers present in the molecular entity are then read from the monomer dictionary;
(f) if the entity is a polymer, then next the polymer entity is built up from the monomers given in the monomer dictionary by creating molecular bonds between the corresponding monomers, forming the polymer entity;
(g) three-dimensional atomic coordinates are then corresponded both to the atoms of the polymer entity and also to the non-polymer entities, using the input descriptor file;
(h) molecular bonds are built next, using the atomic coordinates inserted in step (g) to determine distances: atoms in binding distances are connected by the appropriate molecular bonds, and these bonds are recorded in the database;
(i) the lengths of the molecular bonds are verified next: it is done by taking all pairs of atoms that are in the same descriptor file, and check whether their distance is in accordance with other information in the descriptor file: if the some distance is invalid, then an error is recorded in the output file;
(j) the output is generated from the re-built molecular structures in a suitable machine-readable format.

9. As in claim 8, where the descriptor file is an mmCIF file from the Protein Data Bank.

10. As in claim 8, where the descriptor file is a PDB-file from the Protein Data Bank.

11. As in claim 8, where the descriptor file is an xml-formatted molecular descriptor-file from the Protein Data Bank.

12. As in claim 9, where the monomer dictionary file is the “PDB Chemical Component Dictionary” (it was formerly called “the HET Group Dictionary”).

13. As in claim 10, where the monomer dictionary file is the “PDB Chemical Component Dictionary” (it was formerly called “the HET Group Dictionary”).

14. As in claim 11, where the monomer dictionary file is the “PDB Chemical Component Dictionary” (it was formerly called “the HET Group Dictionary”).

15. A fully automated method for identifying protein-ligand complexes from the Protein Data Bank, comprising the following steps:
(a) the input descriptor mmCIF file is read;
(b) the types of the molecular entities in the descriptor file are identified as polymer or a non-polymer entities;
(c) if the entity is a polymer, then monomer members of the polymer type molecular entity are identified with the help of the “PDB Chemical Component Dictionary” (it was formerly called “the HET Group Dictionary”) of the Protein Data Bank;
(d) if the entity is a polymer, then based on the type of the monomer entities, the type of the polymer entity is determined;
(e) the covalent structure of the monomers present in the molecular entity are then read from the monomer dictionary;
(f) if the entity is a polymer, then next the polymer entity is built up from the monomers given in the monomer dictionary by creating molecular bonds between the corresponding monomers, forming the polymer entity;
(g) three-dimensional atomic coordinates are then corresponded both to the atoms of the polymer entity and also to the non-polymer entities, using the input descriptor file;
(h) molecular bonds are built next, using the atomic coordinates inserted in step (g) to determine distances: atoms in binding distances are connected by the appropriate molecular bonds, and these bonds are recorded in the database;
(i) ligands are identified based on the molecular bonds built in step (h);
(j) ligand binding sites in the protein structures are identified as the neighborhood of the ligands identified in step (i);
(k) the output is generated from the re-built molecular structures, from the list of ligands and from the list of ligand binding sites in a suitable machine-readable format.

16. As in claim 15, where the descriptor file is a PDB-file from the Protein Data Bank.

17. As in claim 15, where the descriptor file is an xml-formatted molecular descriptor-file from the Protein Data Bank.

18. As in claim 15, where the identified ligands are filtered according to chemical and biological relevance.

19. As in claim 15, where the identified binding sites are filtered according to chemical and biological relevance of the corresponding ligand molecules, bound in the binding site in question.

20. As in claim 15, where the identified ligand-protein pairs are filtered for multiple occurrences.
